(19) United States
(12) Patent Application Publication
(10) Pub. No.: US 2015/0276594 A1
(43) Pub. Date: Oct. 1, 2015

(54) METHOD AND APPARATUS FOR MEASURING TURBIDITY

(71) Applicant: Intellectual Property Transfer, LLC, Hollis, NH (US)

(72) Inventors: Joseph E. JOHNSON, Hollis, NH (US); Monique T. CLAVERIE, Farmington, ME (US); Michael J. JOHNSON, Hollis, NH (US); Thomas E. DEVLIN, Somerville, MA (US)

(73) Assignee: Intellectual Property Transfer, LLC, Hollis, NH (US)

(21) Appl. No.: 14/225,798

(22) Filed: Mar. 26, 2014

(51) Int. Cl. G01N 21/53

(52) U.S. Cl. CPC G01N 21/538; G01N 2201/062

(57) ABSTRACT

A method of performing analysis of samples having turbidity and the related apparatus is disclosed. The analysis utilizes information from light scattered from a light path with a detector at an angle of approximately ninety degrees from the light path. The apparatus consists of a light source comprising one or more light emitting diodes, a transparent sample chamber, and a detector comprising a linear variable filter and a photoelectric sensor.

### FIELD OF THE INVENTION

This invention is in the field of turbidity measurements or other turbidity sensing devices. In particular, the present invention relates to providing a compact, reliable and economical apparatus for measuring the turbidity or haziness of fluids.

### BACKGROUND OF THE INVENTION

The measurement of turbidity is used for many applications, the most common being in water quality testing. Specific applications include drinking water, waste water remediation, effluent discharge (e.g., in paper mills, electroplating, quarries, mining operations, and chemical plants), runoff, ocean monitoring, washing of clothes, and filtration processes.

Turbidity is also measured in the beverage industry. Alcoholic drinks (e.g., beer and ales, wine and spirits) involve suspended solids in their processes. Hefeweizen is a style of beer that is hazy by design, due to suspended wheat proteins. Chill haze is an undesirable turbidity that occurs in aged beers that are cold, and is attributed to coagulated proteins, tannins and polyphenols. A filtration process may separate grape skins and particulates from the liquid fraction in wine production. Potato remnants and charcoaled oak are removed from vodka and bourbon, respectively. Fruit drinks may or may not remove suspended pulp from juices. Centrifuges, whirlpools, separators and filters are elements in the quality process for making beverages where turbidity is monitored.

Blood constituents like red blood cells, white blood cells, hemoglobin, lipid particles, bile pigments, bilirubin and biliverdin may be quantified by turbidity measurements. The materials may also interfere with plasma and serum tests and need to be removed, typically by centrifugation and/or filtration, so that a quality test may incorporate turbidity measurements.

In all of the applications, particulate or other matter is often suspended or dispersed in fluids. Such haziness or cloudiness, termed turbidity, is measured by quantitating the amount of scattered light by the particulates. A sensor is typically ninety degrees from the initial light path. The amount of light scattered depends on many factors including the initial intensity of light, the light path, the fluid, the particulate size, shape, concentration and liquid and/or particulate interactions with light, the light scattering path and lengths, and the accuracy of and interaction of light with the sensor.

Tungsten lamps are common light sources in turbidity meters due to their availability and low cost. However, tungsten lamps degrade in light intensity over time which affects turbidity measurements. Frequent calibration by increasing input voltage is necessary to obtain a consistent initial intensity of light. Additionally, a cooling system is often needed for tungsten lamps. Laser light sources are also used, but complex electronics and cooling systems are often needed.

Photodiodes are commonly used sensors that are capable of converting light into either current or voltage. The responsiveness and error of a photodiode is dependent on its material composition and wavelength of light. Smoke detectors, camera light meters, compact disc players, and infrared remote control systems (e.g., television, garage openers and air conditioners) also incorporate photodiodes. Such consumer devices lack a need for a high accuracy, as compared to medical or scientific instruments. Medical applications, e.g., computed axial tomography (CAT scan) or computed tomography (CT scan) where three-dimensional imaging is performed requires highly accurate detectors. Also, scientific instruments like spectrometers and pulse oximeters also have a need for improved accuracy.

Known mechanism exist of using an LED as the light source, but the light source may be limited in being only monochromatic or without an LVF/photo array sensor.

In both U.S. Pat. No. 7,907,282 issued to Coates on 15 Mar. 2011 and U.S. Pat. No. 7,459,713 issued to Coates on 2 Dec. 2008, each of which are herein incorporated by reference, there is discussed potential use of LEDs and an LVF/sensor to measure turbidity.

Previous known implementations discussed above each lack having all of the following properties: a uniform, stable and long-life light source that does not degrade in intensity over time; an accurate sensor that may measure light intensity at one or more wavelengths in the ultraviolet, visible, and infrared regions; and a compact, portable, easy to use instrument. Thus, a need exists for an improved turbidity meter that overcomes the aforementioned issues

### SUMMARY OF THE INVENTION

The present invention relates to instrument and sensor methods and systems. The present invention also relates to instruments that measure the turbidity and quality of fluid having particulate content therein. The present invention additionally relates to linear variable filters combined with photodiode-based sensors and methods thereof. The present invention also relates to light emitting diode devices and methods thereof. The present invention relates to turbidity sensors that monitor or measure the status of a fluid and determine the presence or level of particulates in or materials having different optical properties of the fluid. The present invention also relates to techniques for measuring concentrations of particulate matter in fluids.

A turbidimeter for measuring the turbidity of a sample of fluid comprises a transparent sample cell containing the sample, a light source comprising one or more light emitting diodes that directs a beam of light through the sample cell, and a light detector comprising of a linear variable filter coupled with a photoelectric sensor. The incoming light beam is typically at a ninety degree angle to the light detector, allowing scattered light to be measured. The arrangement is a compact apparatus, with no moving parts.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of an overhead view of key components of the turbidity instrument.

FIG. 2 is a schematic of the turbidity apparatus showing the cuvette adapter and key components.

FIG. 3 is a schematic of the side view of a modified cuvette adapter.

FIG. 4 is a schematic of the cut-out view of a modified cuvette adapter.

FIG. 5 is a schematic of the side view of the cuvette holding cell of a modified cuvette adapter.

FIG. 6 is a correlation curve of Formazin standards vs. Transmission at 580 nm for an i-LAB® Turbidity Meter.

### DETAILED DESCRIPTION

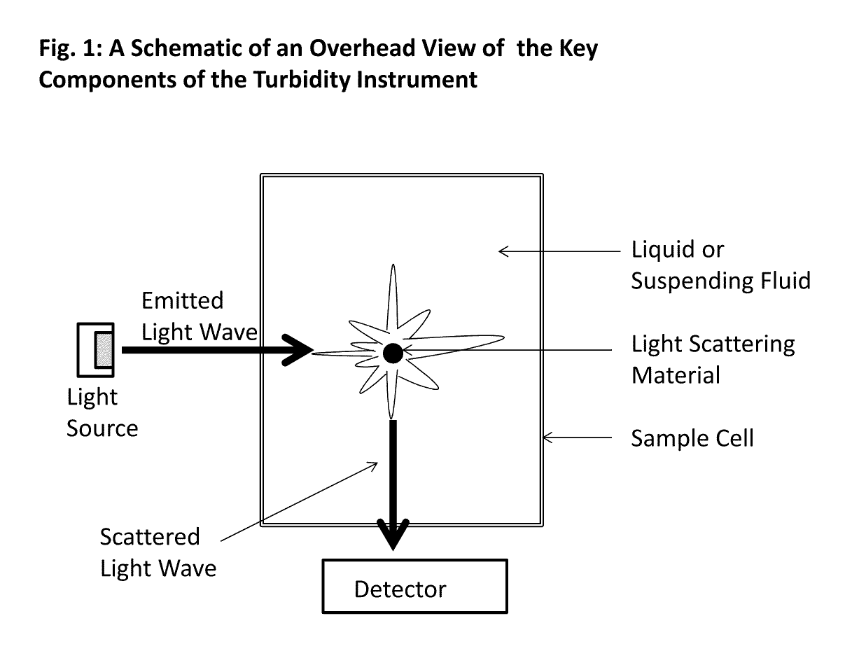

The schematic in FIG. 1 is an overhead view of the turbidity instrument that is comprised of a light source—that generates an emitted light wave, a scattering material in a liquid or suspending fluid that is a sample cell, a resultant scattered light wave and a detector. The light source may be one or more LEDs. The detector is composed of a linear variable filter and a photo detector.

In terms of the inventive method and apparatus, it should be noted that the position of the LED or LEDs creates a light path that may be detected at angles not considered transmissive (i.e., non-transmissive angles), meaning zero degrees, or reflective, meaning one-hundred eighty degrees, but rather at an angle between, but not including, zero and one-hundred and eighty degrees, preferrably as ninety degrees. The LEDs emit light covering single or multiple wavelengths and detection of light within a fluid under test includes identifying a detected wavelength at a different wavelength or wavelengths from that emitted by the LEDs, such as in fluorescent, luminescent or phosphorescent processes.

The schematic shows the light scattering and detection process. An emitted light wave impinges onto a material which differs from the suspending fluid. The difference may due to, but is not limited by, size (e.g., at the molecular level or larger) or to refractive index, or both. Upon impingement, the material absorbs and scatters light based on its composition, size, and shape. The scattered light at 90 degrees is then detected and quantitated at the detector, and the instrument yields intensity of light at given wavelengths. Typically, turbidity or nepholemetry uses a scattering angle at 90 degrees from the emitted or incident light path.

In reality, there is a quantity of the scattering material, as opposed to just one as shown in the figure, and multiple light interactions, such as secondary scattering, are occurring between different materials or particles. However, the schematic shows the components and their relative placement, and to illustrate a simplified light scattering process.

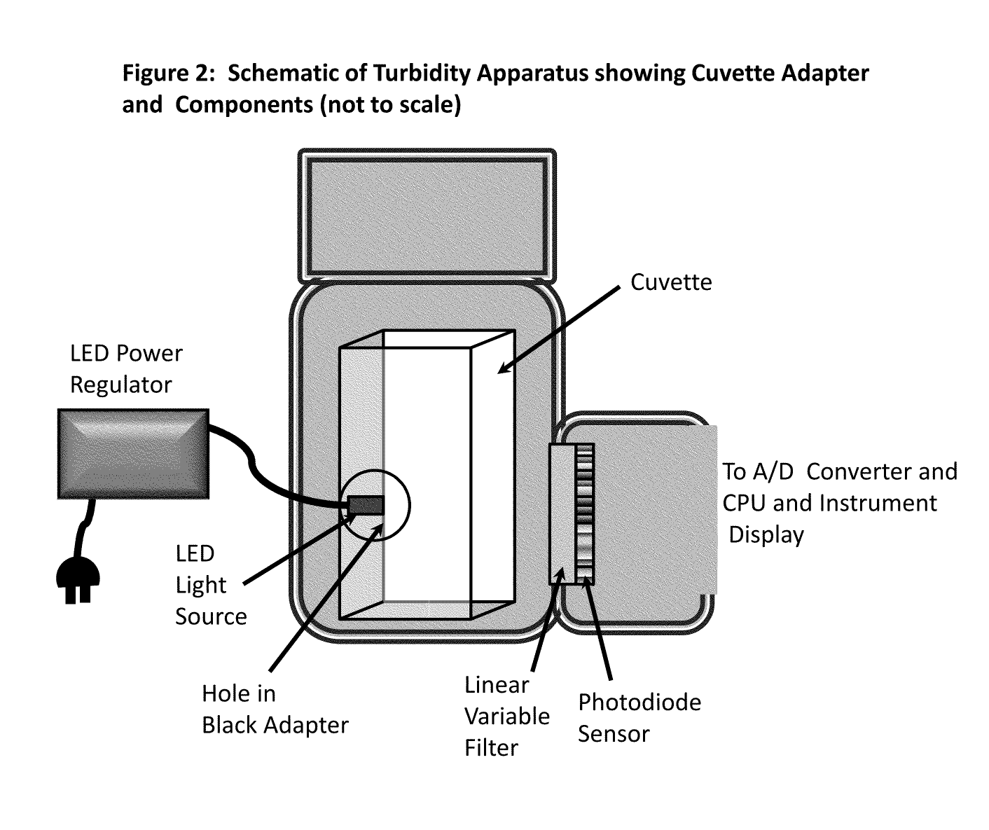

FIG. 2 is a schematic of the turbidity apparatus showing the cuvette adapter and key components. An LED light source is powered by an external source, although conversion of the firmware can allow the instrument to power the LED or be internally powered. The LED is attached to the inside wall of a black adapter. The black adapter does not allow external light to interact with the sample; in other words, the black adapter is used to prevent external stray light. Multiple LEDs may also be utilized. The light from the LED is focused through a cuvette where it interacts with the sample and is scattered. The light scattered at 90 degrees is measured with the detector, which is comprised of a linear variable filter and a photodiode sensor. The analog data is then converted to digital data via an A/D converter, processed with a CPU, stored in the instrument and displayed on the instrument's display. The stored data can be externally sent to a computer using software.

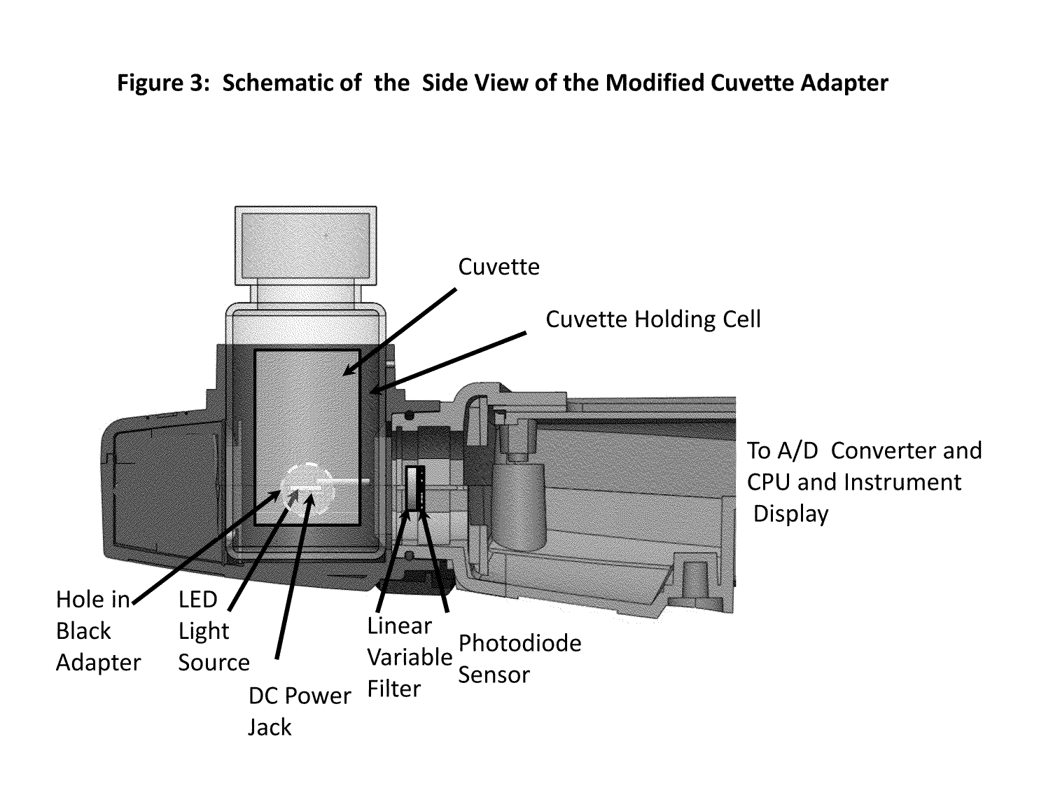

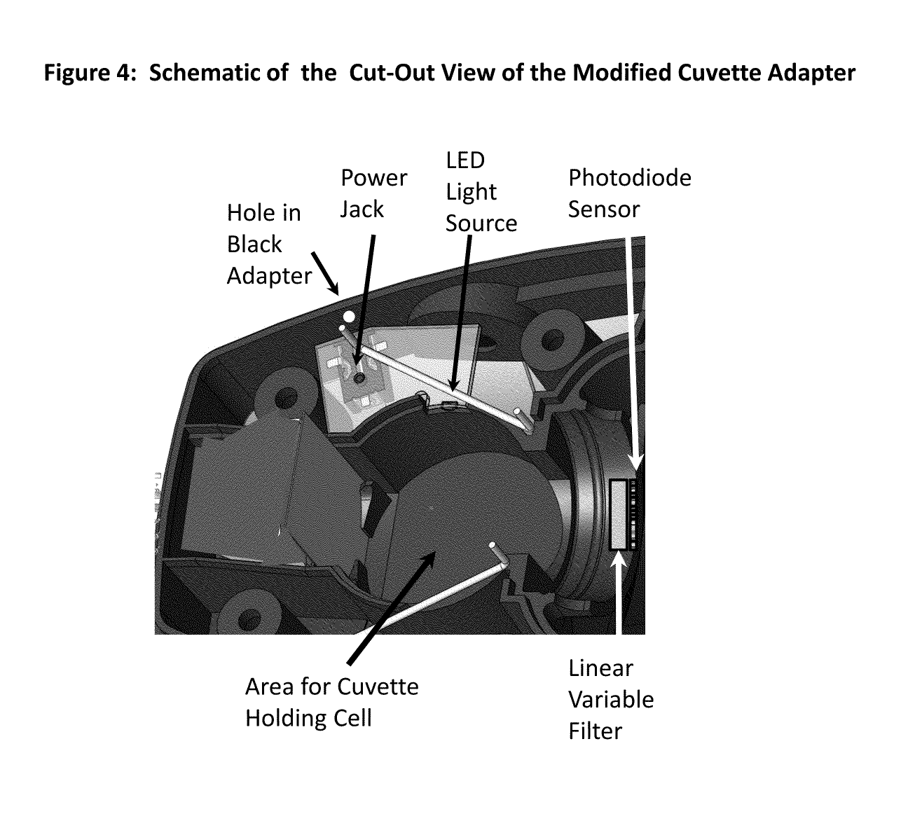

FIGS. 3 and 4 are schematics of the modified cuvette adapter at different viewing angle, with the relative placement of light scattering components. FIGS. 3 and 4 provide greater detail than FIG. 2 and were used as initial engineering blue-prints for relative component size and placement.

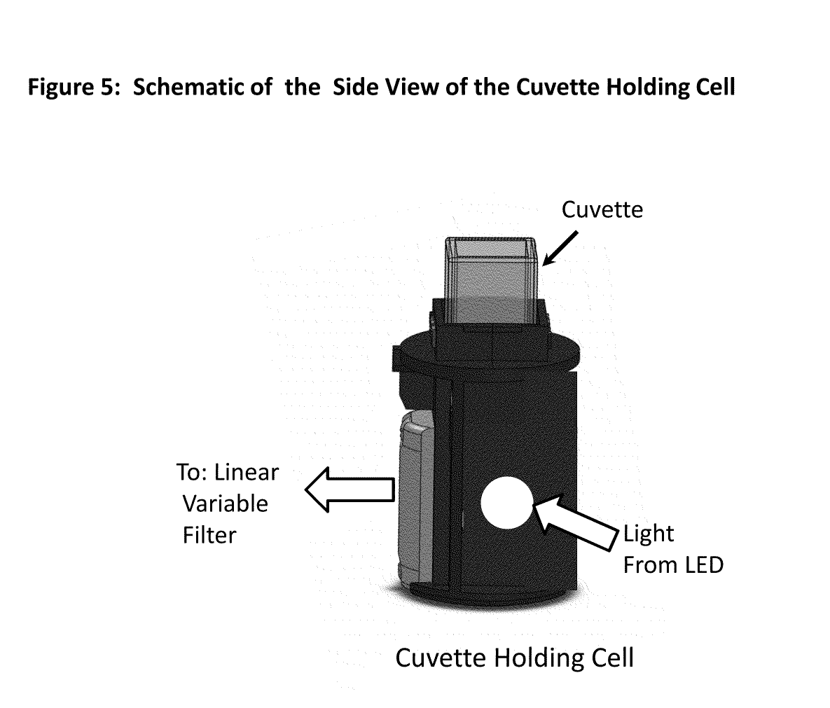

FIG. 5 is a schematic of the cuvette holding cell. The cell has a hole in its side from which light from one or more LEDs can shine through it and into a sample inside a cuvette. A transparent window made of optical-grade plastic or glass is 90 degrees from the hole, allowing scattered light from a sample to further go to a linear variable filter to be separated into individual wavelengths and a detector.

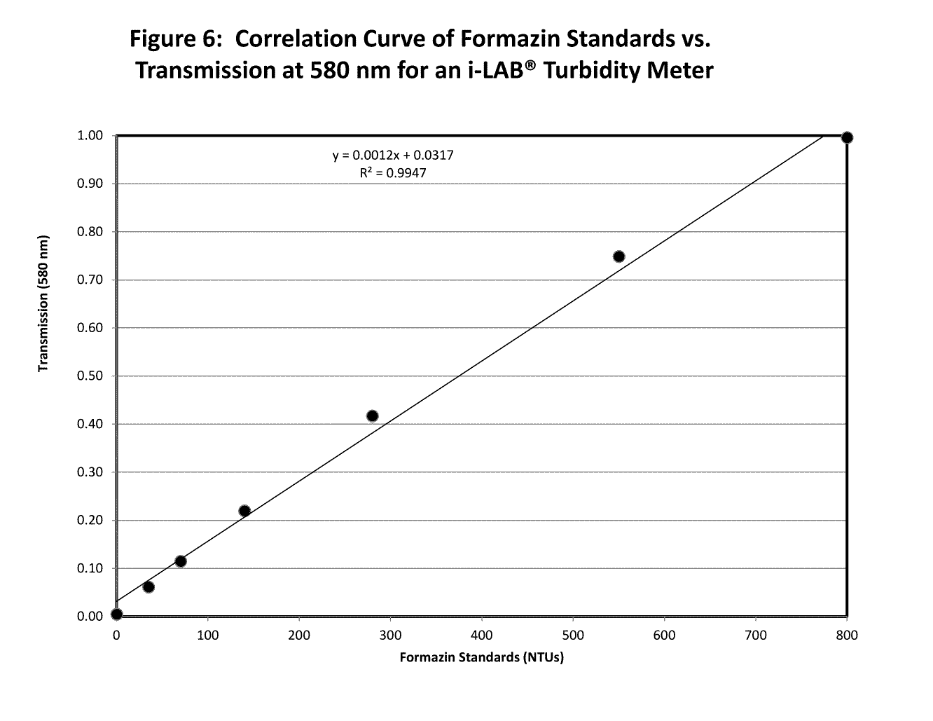

FIG. 6 is the correlation curve of Formazin standards plotted against Transmission of light at 580 nm.

Reference will be made to examples of the present invention.

### Example 1

This example demonstrates the layout and composition of the turbidity meter. A spectrophotometer (i-Lab® Model S560 from Microspectral Analysis, LLC of Wilton, Me., USA) was used with a modified adapter, where said adapter has an LED light source that shines a beam of light through a sample such that the emitted light path is at an angle of 90 degrees from the detector. The adapter and cuvette holding cell were modified as described above in FIGS. 2-5. The modification consisted of attaching a right angle surface mount technology LED (SMLA13WB, bright white LED, Rohm) and a DC (direct current) connecting jack inside the adapter's internal cavity walls. Further a small hole was also bored out of the external adapter wall, and a USB mini-cord was inserted such that it connects to the jack. The USB cord was connected to an external power supply. The spectrometer inherently measures light intensity, and records such intensity from 400 nm to 700 nm in 1 nm increments. Turbidity measurements were made at 580 nm in accordance the ASBC Standards.

### Example 2

Formazin turbidity standards were made in accordance with ASBC Methods of Analysis 26-Formazin, and used within 24 hours. A standard of 1000 NTU (nepholometric transmission units) was used to make calibration standards. A graph of the NTU standards is shown in FIG. 5. From the figure, there is an excellent relationship between the NTU concentration and the Transmission at 580 nm, as evidenced by a calculated correlation constant (R²) of 0.9947.

### Example 3

Three different types of beers from Allagash Brewing Co., Portland, Me., were tested for turbidity. The beers used were the Allagash White, the Allagash Dubbel, and the Allagash Tripel. The Allagash White and Dubbel are considered “hazy” beers. The measurements were made using a calibrated, i-LAB® turbidity meter and a Haach 2100N bench-top turbidity meter (Haach Co., Loveland, Colo.). Ten measurements were made for both the i-LAB turbidity meter and the Haach instrument. The average turbidity was reported for both instruments, as well as the range (high and low values) for the i-LAB turbidity meter.

The results explained in Example 3 are shown below in Table 1 which include the turbidity measurement results for three beers. Here, the turbidity measurement for each beer type correlates to the visual appearance; i.e., for the hazy beers the Transmission of scattered light at 580 nm was >0.110 and the turbidity >67, and the “non-hazy”, transparent beer had a Transmission readings of <0.05 with a turbidity of <16. Further, the turbidity range is narrow and typically varies only +/−2.5 NTUs. This example shows that the i-LAB® turbidity meter can be used for a realistic application (in this case to quantitate the haze in beer), and that the measurements are narrow in range, and that the turbidity determinants are accurate and similar to those of a commercial, bench-top turbidimeter.

TABLE 1

| | | | | | Haach |
|---|---|---|---|---|---|
| | | Trans- | | Turbidity | 2100 N |
| | Visual | mission | Turbidity | Range | Turbidity |
| BEER | Appearance | (580 nm) | (NTU) | (NTU) | (NTU) |
| Allagash | Hazy, | 0.117 | 72 | 70-75 | 75 |
| White | Transparent | | | | |
| Allagash | Hazy, | 0.116 | 70 | 68-73 | 71 |
| Dubbel | Transparent | | | | |
| Allagash | Transparent | 0.045 | 11 | 10-15 | 14 |
| Tripel | | | | | |

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for determining turbidity of fluids using a device having a light source with one or more light emitting diodes (LEDs), a sample chamber for maintaining a sample therein, and a detector with a linear variable filter and a photoelectric detector, said method comprising:
scattering light within a fluid under test by positioning one or more LEDs to create a light path detectable at non-transmissive angles;
detecting said light emitted from said fluid under test; and
determining turbidity based upon said light emitted.

2. The method of claim 1 wherein the non-transmissive angles include a range of more than zero degrees and less than one-hundred and eighty degrees.

3. The method of claim 2 wherein the range is limited to ninety degrees.

4. The method of claim 1 wherein the linear variable filter separates light scattering information into one or more wavelengths.

5. The method of claim 1 wherein nepholometric units are measured and related to properties including concentration of one or more light scattering materials selected from the group consisting of slurries, dispersions, emulsions, mixtures and solutions.

6. The method of claim 1 wherein the LEDs emit light covering single or multiple wavelengths in the ultraviolet, visible and infrared regions.

7. The method of claim 1 wherein the LEDs emit light in the 180 nm to 1050 nm region.

8. The method of claim 1 wherein the LEDs emit visible light covering single or multiple wavelengths in a preferred region of 400 nm to 700 nm.

9. The method of claim 1 wherein the LEDs emit ultraviolet light covering single or multiple wavelengths in the 180 nm to 400 nm region.

10. The method of claim 1 wherein the LEDs emit infrared light covering single or multiple wavelengths in the 600 nm to 1050 nm region.

11. The method of claim 1 wherein the LEDs emit light covering single or multiple wavelengths and said detecting step detects a detected wavelength at a different wavelength or wavelengths.

12. A measurement apparatus for determining turbidity of fluids, said apparatus comprising:
a light source with one or more light emitting diodes (LEDs), the light source arranged for scattering light within a fluid under test by positioning said LEDs to create a light path detectable at non-transmissive angles;
a sample chamber for maintaining a sample of fluid under test therein;
a detector with a linear variable filter and a photoelectric detector, said detector arranged for detecting said light emitted from said fluid under test; and
a processor for determining turbidity based upon said light emitted.

13. The apparatus of claim 12 wherein the non-transmissive angles include a range of more than zero degrees and less than one-hundred and eighty degrees, and preferably ninety degrees.

14. The apparatus of claim 12 wherein the linear variable filter separates light scattering information into one or more wavelengths.

15. The apparatus of claim 12 wherein nepholometric units are measured and related to properties including concentration of one or more light scattering materials selected from the group consisting of slurries, dispersions, emulsions, mixtures and solutions.

16. The apparatus of claim 12 wherein the LEDs emit light covering single or multiple wavelengths in the ultraviolet, visible and infrared regions.

17. The apparatus of claim 12 wherein the LEDs emit light in the 180 nm to 1050 nm region.

18. The apparatus of claim 12 wherein the LEDs emit visible light covering single or multiple wavelengths in a preferred region of 400 nm to 700 nm.

19. The apparatus of claim 12 wherein the LEDs emit ultraviolet light covering single or multiple wavelengths in the 180 nm to 400 nm region.

20. The apparatus of claim 12 wherein the LEDs emit infrared light covering single or multiple wavelengths in the 600 nm to 1050 nm region.
